(19) United States
(12) Patent Application Publication
(10) Pub. No.: US 2010/0078196 A1
(43) Pub. Date: Apr. 1, 2010

(54) CATEGORY CABLE USING DISSIMILAR SOLID MULTIPLE LAYER

(76) Inventors: Thomas McLaughlin, Taylor Mill, KY (US); Kenneth Cornelison, Cincinnati, OH (US)

Correspondence Address: BLANK ROME LLP, WATERGATE, 600 NEW HAMPSHIRE AVENUE, N.W., WASHINGTON, DC, 20037, US

(21) Appl. No.: 11/960,293

(22) Filed: Dec. 19, 2007

(51) Int. Cl. H01B 7/295; H01R 43/00

(52) U.S. Cl. 174/120 SR; 29/825

(57) ABSTRACT

A flame retardant cable having a conductor, an inner polyolefin insulation layer surrounding the conductor having a first dielectric constant and a first limiting oxygen index, and a least one outer polyolefin insulation layer surrounding the inner insulation layer conductor having a second dielectric constant and a second limiting oxygen index. The first limiting oxygen index and the second limiting oxygen index may be different or the first and second dielectric constants may be different.

### FIELD OF THE INVENTION

The present invention relates to flame retardant cable for telecommunications. More particularly, the present invention is directed to an insulated conductor having at least two insulation layers, each layer having a different dielectric constant (“k”), a different limiting oxygen index (“LOI”), different flame retardant additive technologies, or other differences that would result in the use of a different compound in each layer. Telecommunication cable prepared with one or more twisted pairs of such insulated conductors is particularly well-suited for use in plenum spaces of air circulation systems.

### BACKGROUND OF THE INVENTION

In the construction of buildings, it is extremely important to use materials which resist the spread of flame and the generation and spread of smoke in case of fire. Accordingly, it is important to select and install telecommunications cable meeting specific flame retardant material requirements.

Industry recognized tests have been developed for plenum cable applications, for example, the NFPA 262 test developed by the National Fire Protection Association. “Standard Method of Test for Flame Travel and Smoke of Wires and Cables for Use in Air-Handling Spaces” prescribes the methodology to measure flame travel distance and optical density of smoke for insulated, jacketed, or both, electrical wires and cables and optical fiber cables that are to be installed in plenums and other spaces used to transport environmental air without being enclosed in raceways. This test requires a single layer of 24 foot cable lengths in a one foot wide tray to be subjected to ignition by a 300,000 BTU/hr methane flame. Flame spread is aided by a 240 ft/minute draft during the 20 minute test in which both flame spread and smoke generation are measured.

Fluorinated polymers, such as fluorinated ethylene propylene (“FEP”), have often been used on conductors in a uniform twisted pair (UTP) plenum cable; however, the cost of such construction is high and supply of the material is often a concern. This type of twisted pair cable, where all pairs are insulated with FEP, may be referred to as an ‘all fluoro’ cable, and in the case of a four pair cable would be referred as a “4×0” cable, for four pairs of FEP and zero pairs of alternate insulation material.

U.S. Pat. Nos. 5,936,205 and RE 37,010 to Newmoyer propose a 3×1 construction wherein each conductor of the three twisted pairs has a single surrounding layer of FEP electrical insulation and the remaining one twisted pair has a single surrounding layer of an olefin insulation. This configuration suffers from an inability to tune both the electrical and flame retardant properties with characteristics of the single layer of olefin insulation material.

U.S. Pat. No. 5,563,377 to Arpin et al proposes a telecommunications cable for plenum chamber use having a cable core in which each conductor is surrounded by an individual dual layer insulation of an inner layer of flame retardant polyolefin and an outer layer of FEP. This construction suffers from several drawbacks, however, including the need for expensive FEP, slower line speeds for production of an FEP over olefin construction, and delamination of the dissimilar FEP and olefin layers.

TIA/EIA 568B standards set electrical requirements for Category 5e, 6 and 6a cables. For Category 5e, requirements for, attenuation, return loss, near end crosstalk and equal level far end crosstalk are given for each conductor pair for 100 meters of cable as follows: attenuation should not be higher than 2.0 to 22 dB, depending on testing frequency of 1 MHz to 100 MHz, return loss should be no less than 17 to 25 dB, depending on the testing frequency of 1 MHz to 100 MHz, near end crosstalk should not be lower than 67.0 to 35.3 dB, depending on testing frequency of 772 kHz to 100 MHz; and equal level far end crosstalk should not be lower than 60.8 to 20.8 depending on testing frequency of 1 MHz to 100 MHz. For Category 6 cables, attenuation, return loss, near end crosstalk and equal level far end crosstalk are given for each conductor pair for 100 meters of cable as follows: attenuation should not be higher than 2.0 to 32.8 dB, depending on testing frequency of 1 MHz to 250 MHz, return loss should be no less than 20.0 to 17.3 dB, depending on the testing frequency of 1 MHz to 250 MHz, near end crosstalk should not be lower than 74.3 to 38.3 dB, depending on testing frequency of 772 kHz to 250 MHz; and equal level far end crosstalk should not be lower than 67.8 to 19.8 depending on testing frequency of 1 MHz to 250 MHz. For Category 6a cables, attenuation, return loss, near end crosstalk, attenuation to crosstalk ratio far end, alien near end crosstalk and alien equal level far end crosstalk are given for each conductor pair for 100 meters of cable as follows: attenuation should not be higher than 2.1 to 45.3 dB, depending on testing frequency of 1 MHz to 500 MHz, return loss should be no less than 20.0 to 15.2 dB, depending on the testing frequency of 1 MHz to 500 MHz, near end crosstalk should not be lower than 76.0 to 33.8 dB, depending on testing frequency of 772 kHz to 500 MHz; attenuation to crosstalk ratio far end, should not be lower than 67.8 to 13.8 depending on testing frequency of 1 MHz to 500 MHz, alien near end crosstalk should not be lower than 67.0 to 52.0 dB, depending on testing frequency of 1 MHz to 500 MHz; and attenuation to alien crosstalk ratio far end; should not be lower than 67.0 to 24.2 dB, depending on testing frequency of 1 MHz to 500 MHz

Impedance and attenuation are important electrical properties. Impedance is the resistance to signal transmission along the length of the cable. The impedance of cable is controlled by conductor diameter and its properties, type of insulation used and its thickness, and tightness with which individual pairs are twisted. Thicker insulation gives higher impedance. But if insulation is too thick, the cable impedance can exceed the maximum desired value. Attenuation is the reduction in signal strength over the distance the signal is transmitted. Conductor and insulation are the major contributors to cable attenuation. The larger the conductor or lower the resistance results in lower attenuation. The greater the insulation thickness also gives lower attenuation.

The dielectric properties of insulation, i.e., the dielectric constant “k” has an impact on the velocity at which the electrical signal travels in the conductor wire. Thus, for a 3×1 cable construction with 3 pairs having a single layer of FEP insulation and one pair having single layer of olefin insulation, other adjustments need to be made in cable design to accommodate the differing dielectric constants of FEP and the single layer olefin. These adjustments are often made in the amount or frequency of twisting per linear length that the two conductors in a pair are wrapped around each other, which is often referred to as pair twist or lay.

When certain less costly foam/skin insulation configurations are used with 4×0 FEP constructions and twisted tightly together in a pair, the foam may be crushed causing the center-to-center distance of between the conductors to vary in that pair. This center-to-center distance variation in a pair has undesirable consequences, including increased interference, which are described in commonly assigned U.S. Pat. No. 5,767,441 to Brorein et al., the subject matter of which is incorporated herein in its entirety.

Thus, the need exists for a cable insulation design that may be used commercially and provides cost savings with the ability to tune or adjust the electrical and flame retardant properties and characteristics of the olefin insulation material.

### SUMMARY OF THE INVENTION

In one embodiment, the invention provides a flame retardant cable having a conductor; an inner polyolefin insulation layer surrounding the conductor having a first dielectric constant and a first limiting oxygen index; and an outer polyolefin insulation layer surrounding the inner insulation layer conductor having a second dielectric constant and a second limiting oxygen index. The first limiting oxygen index and the second limiting oxygen index are different.

In other preferred embodiments of the invention, the first dielectric constant and the second dielectric constant are different. In yet other preferred embodiments of the invention, the inner polyolefin insulation layer and the outer polyolefin insulation layer are different polyolefins. In further embodiments of the invention, the first limiting oxygen index may be (a) greater than or (b) less than the second limiting oxygen index. Preferably, the first limiting oxygen index is less than the second limiting oxygen index. Similarly, the first dielectric constant may be (a) greater than or (b) less than the second dielectric constant.

The inner polyolefin insulation layer may comprise a base polyolefin comprising polyethylene, polypropylene or copolymers or blends thereof. The outer polyolefin insulation layer may comprise a base polyolefin comprising polyethylene, polypropylene or copolymers or blends thereof.

A more complete appreciation of the invention and many of the attendant advantages thereof will be readily obtained as the same becomes better understood by reference to the following detailed description when considered in connection with the accompanying drawings, wherein:

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a sectional view of an insulated conductor according to an embodiment of the present invention showing inner and outer layers of insulations; and

FIG. 2 is a sectional view of four twisted pairs of insulated conductors showing at least one pair with multiple layers of insulation in accordance with an embodiment.

### DETAILED DESCRIPTION OF THE INVENTION

Polyolefins are inherently combustible materials. To obtain polyolefin polymers with improved flame resistance it is known to incorporate various additives into the polymer, such as halogen based chemicals, phosphate based chemicals, inorganic hydroxide/hydrated compounds, ethylene diamine phosphate, melamine, melamine pyrophosphate, melamine phosphate, ammonium polyphosphate, melamine polyphosphate, calcium carbonate, talc, clay, organo-modified clay, calcium hexaborate, alumina, titanium oxides, carbon nanotubes, zinc borate, wollastonite, mica, silicone polymers, phosphate esters, hindered amine stabilizers, melamine octomolybdate, ammonium octomolybdate, expandable graphite, frit, hollow glass beads, polyarylene ethers, microparticles, fillers, nanoparticles such as nanoclays and nanoplatelets, phosphorus, and organosilicon compounds and mixtures thereof. Compounds based on such compositions usually show good flame retardancy, e.g. in the limiting oxygen index (LOI) test method according to ASTM 2863.

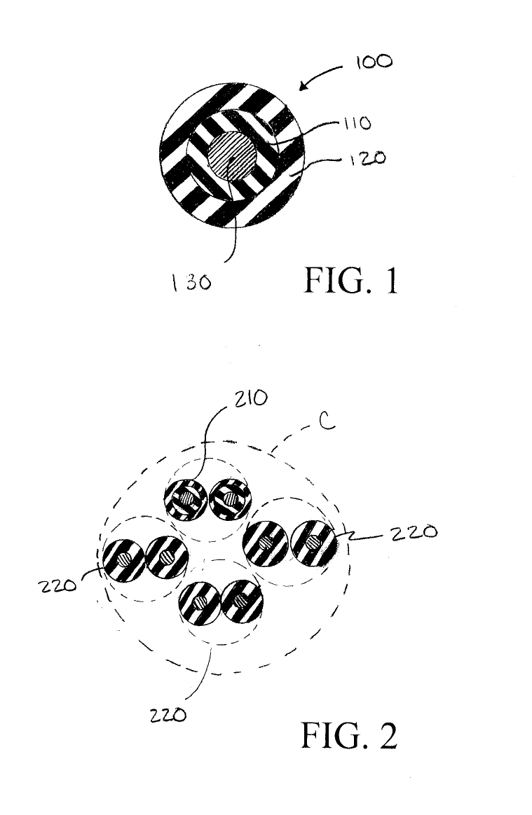

For a flame retardant insulated conductor or cable comprising such an insulated conductor, such as insulated conductor 100 of FIG. 1, it has been unexpectedly and surprisingly found that an insulated conductor, having at least two insulation layers, such as inner and outer layers 110 and 120 shown in FIG. 1, surrounding a conductor 130, with the layers 110 and 120 having different LOI's represents a significant improvement over single layer polyolefin constructions.

In preferred embodiments of the invention, the LOI of the outer layer of insulation may be greater than that of the inner layer insulation. In general, a higher LOI material formulated for a single layer mixed pair construction will exhibit good flame and smoke properties at the expense of a higher dielectric constant. This increased dielectric constant can result in failure of the transmission requirements of the individual Category cable and/or limit the candidates of useful material in a single layer design. An example would be insulation with a dielectric constant of 2.8. In order to reduce the dielectric constant to a suitable level, below 2.65, and take advantage of the flame and smoke suppressant properties of a higher LOI material, a dual insulation is used. In one such design, an inner layer exhibiting a lower dielectric constant when combined with the outer layer with higher dielectric constant, resulted in an effective dielectric constant which yields passing transmission characteristics. In this design, the higher LOI material, which exhibits better flame and smoke suppressant properties, is used as an outer shell to protect the inner lower LOI material and generates passing NFPA 262 results which are an improvement over the single layer mixed pair construction.

If higher LOI values are selected in a polymeric conductor insulation material, the NFPA 262 test results are satisfactory or better but the electrical properties suffer because of the degradation of the dielectric properties caused by the flame retardant additives in the insulation. Conversely, if lower LOI values are selected in a polymeric conductor insulation material, the NFPA 262 test results are not satisfactory but the electrical properties are acceptable because the degradation of the dielectric properties caused by the level flame retardant additives in the insulation is reduced by the reduction of the level of additives.

Accordingly, it is an aspect of the invention that both the first LOI and first dielectric constant and the second LOI and the second dielectric constant, as properties of the inner and outer layers, respectively, are balanced in combination to provide a finely tuned dual layer (or greater than dual layer) insulation with flame and smoke resistant and electrical properties that exceed the conventional single layer polyolefin constructions. This is especially true in FEP/olefin mixed pair configurations.

In preferred embodiments of the invention, the dielectric constant of the outer layer may be greater than that of the inner layer. Preferably, the dielectric constant of the inner and outer layers combined should be less than around 2.65.

Examples of polyolefins useful in the present invention include polyethylene polymers, polypropylene polymers, ethylene terpolymer, ethylene propylene diene terpolymers (EPDM) or ethylene-propylene rubbers.

Polyethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene. The polyethylene can also be a copolymer of ethylene and an unsaturated ester such as a vinyl ester (e.g., vinyl acetate or an acrylic or methacrylic acid ester) or a copolymer of ethylene and a vinyl silane (e.g., vinyltrimethoxysilane and vinyltriethoxysilane). A third comonomer can be included, e.g., another alpha-olefin or a diene such as ethylidene norbornene, butadiene, 1,4-hexadiene, or a decyclopentadiene.

Ethylene/propylene/diene terpolymers are generally referred to as an EPDM and ethylene/propylene copolymers are generally referred to as EPRs. For EPDM, the third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The overall combined thickness of the inner and outer insulation layers will depend on the attenuation requirement of the cable Category, the effective dielectric constant of the insulation layers and the pair lay. As an example, Category 5e, which has a lower attenuation requirement than Category 6, will have an overall diameter from about 0.034″ to 0.037″ of insulation while the overall diameter of Category 6 is about 0.039″ to 0.044″ of insulation. Given a lower effective dielectric constant of the insulation layers, the overall diameter will be lower. A pair with a longer pair lay will have a smaller overall diameter than a pair with a shorter pair lay.

### EXPERIMENTAL

The following non-limiting example illustrates the present invention showing use of at least one dual layer insulation pair passes the NFPA 262 test.

In the example, a 24 AWG conductor with a diameter of 0.0206″ is insulated with an inner polyolefin insulation layer surrounding the conductor having a dielectric constant value 2.31 and a limiting oxygen index value of 29; and an outer polyolefin insulation layer with a dielectric constant value of 2.7 and a limiting oxygen index value of 34. The thickness of the inner layer is 0.003″, the outer layer thickness is 0.00475″, with a combined total insulation thickness of 0.036″.

Table 1 below illustrates the NFPA 262 test results of a 3×1 construction using one pair with a single layer of flame retardant insulation versus a 3×1 construction with one pair using a dual layer flame retardant insulation, such as shown in FIG. 2. FIG. 2 illustrates a cable C having a plurality of twisted pairs of insulated conductors wherein one pair 210 uses a dual layer of insulation in accordance with the invention and the remaining pairs 220 have a single layer of insulation. Both constructions used the same PVC formulation for the jacket material.

TABLE 1

| | | | Average | |
|---|---|---|---|---|
| | Flame | Peak Optical | Optical | |
| Core Description | Distance | Density | Density | Result |
| 3 FEP & 1 single layer | 3.0 | 0.73 | 0.14 | Fail |
| insulated pair | | | | |
| 3 FEP & 1 dual layer | 2.0 | 0.49 | 0.11 | Pass |
| insulated pair | 2.0 | 0.38 | 0.11 | Pass |
| UL Sec. Max. | 5.0 | 0.50 | 0.15 | |

While particular embodiments have been chosen to illustrate the invention, it will be understood by those skilled in the art that various changes and modifications can be made herein without departing from the scope of the invention as defined in the appended claims. For example, additional outer layers of insulation may be used to create a multi-layer insulation for the wire pairs.

What is claimed is:

1. A flame retardant cable comprising of:
(i) a conductor;
(ii) an inner insulation layer surrounding the conductor, the inner insulation layer being formed of a polyolefin based compound having a first dielectric constant and a first limiting oxygen index; and
(iii) at least one outer insulation layer surrounding the inner insulation layer, the outer insulation layer being formed of a polyolefin based compound having a second dielectric constant and a second limiting oxygen index, wherein the first limiting oxygen index and the second limiting oxygen index are different.

2. The cable of claim 1, wherein
the first dielectric constant and the second dielectric constant are different.

3. The cable of claim 1, wherein
the inner insulation layer and the outer insulation layer are different polyolefin based compounds.

4. The cable of claim 1, wherein
the first limiting oxygen index is greater than the second limiting oxygen index.

5. The cable of claim 1, wherein
the first limiting oxygen index is less than the second limiting oxygen index.

6. The cable of claim 2, wherein
the first dielectric constant is greater than the second dielectric constant.

7. The cable of claim 2, wherein
the first dielectric constant is less than the second dielectric constant.

8. The cable of claim 3, wherein
the inner insulation layer comprises a base polyolefin comprising polyethylene.

9. The cable of claim 3, wherein
the inner insulation layer comprises a base polyolefin comprising polypropylene.

10. The cable of claim 3, wherein
the outer insulation layer comprises a base polyolefin comprising polyethylene.

11. The cable of claim 3, wherein
the outer insulation layer comprises a base polyolefin comprising polypropylene.

12. The cable of claim 1, further comprising
a second outer layer of insulation formed of a polyolefin based compound.

13. A flame retardant cable, comprising of:
(i) a conductor;
(ii) an inner polyolefin compound insulation layer surrounding the conductor having a first dielectric constant and a first limiting oxygen index; and
(iii) at least one outer polyolefin compound insulation layer surrounding the inner insulation layer conductor having a second dielectric constant and a second limiting oxygen index, wherein the first dielectric constant and the second dielectric constant are different.

14. The cable of claim 13, wherein
the inner polyolefin insulation layer and the outer polyolefin insulation layer are different polyolefin compounds.

15. The cable of claim 13, wherein
the first limiting oxygen index is greater than the second limiting oxygen index.

16. The cable of claim 13, wherein
the first limiting oxygen index is less than the second limiting oxygen index.

17. The cable of claim 13, wherein
the first dielectric constant is greater than the second dielectric constant.

18. The cable of claim 13,
wherein the first dielectric constant is less than the second dielectric constant.

19. The cable of claim 13, wherein
the inner polyolefin insulation layer comprises a base polyolefin compound comprising polyethylene.

20. The cable of claim 13, wherein
the inner polyolefin insulation layer comprises a base polyolefin compound comprising polypropylene.

21. The cable of claim 13, wherein
the outer polyolefin insulation layer comprises a base polyolefin compound comprising polyethylene.

22. The cable of claim 13, wherein
the outer polyolefin insulation layer comprises a base polyolefin compound comprising polypropylene.

23. The cable of claim 13, further comprising
an second outer layer of insulation formed of a polyolefin based compound.

24. A method of making a flame retardant cable, the cable having at least one conductor, comprising the steps of:
surrounding the conductor with a first insulation layer, the first insulation layer being formed of a polyolefin based compound having a first dielectric constant and a first limiting oxygen index; and
surrounding the conductor and the first insulation layer with a second insulation layer, the second insulation layer being formed of a polyolefin based compound having a second dielectric constant and a second limiting oxygen index, wherein either the first and second dielectric constants differ or the first and second limiting oxygen indexes differ.
